(19) United States
(12) Patent Application Publication
(10) Pub. No.: US 2020/0283603 A1
(43) Pub. Date: Sep. 10, 2020

(54) ANTIMICROBIAL FORMULATION FOR RUBBER PLUCKER/DEHAIRER FINGERS

(71) Applicant: LUIZ ANTONIO RASSELI, Barreiro de Baixo (BR)

(72) Inventor: LUIZ ANTONIO RASSELI, Barreiro de Baixo (BR)

(21) Appl. No.: 16/648,299

(22) PCT Filed: Dec. 21, 2017
(86) PCT No.: PCT/BR2017/000155

§ 371 Date: Mar. 18, 2020

(30) Foreign Application Priority Data
Sep. 29, 2017 (BR) BR 102017020970-9

(51) Int. Cl. C08L 9/06; C08K 5/00; C08K 5/17; C08L 7/00; C08L 9/02; C08L 75/04; C08K 3/015

(52) U.S. Cl. CPC C08L 9/06; C08K 5/0016; C08K 5/005; C08K 3/015; C08L 7/00; C08L 9/02; C08L 75/04; C08K 5/17

(57) ABSTRACT

The present invention patent applies to the food industry, particularly to the sectors of poultry mechanical plucking and pig dehairing machines, and refers to the antimicrobial formulation for creating rubber compound materials aimed at manufacturing products based on such processes as injection molding, high temperature heat transfer or press vulcanization/curing, to be used in poultry plucking machines or in pig dehairing machines.

The present invention patent applies to the food industry, particularly to the sectors of poultry mechanical plucking and pig dehairing machines, and refers to the antimicrobial formulation for creating rubber compound materials aimed at manufacturing products based on such processes as injection molding, high temperature heat transfer or press vulcanization/curing, to be used in poultry plucking machines or in pig dehairing machines.

Rubber fingers are currently used by slaughterhouses in poultry plucking machines and in pig dehairing machines. The useful life of parts available in the market for poultry plucking and pig dehairing machines is very low as they wear out and eventually break down during the process. Aside from building up waste that is both undesirable and harmful to end users health, these parts have no antibacterial protection, thereby favoring the fixation and proliferation of bacteria, mainly salmonella, and impairing food safety.

Current pre-vulcanized rubber compounds and vulcanized rubber products with antimicrobial properties use non-sulfur-based curing agents, such as bisphenol A and silver hydrogen peroxide.

A PI 0409713-0—“Pre-vulcanized antimicrobial rubber compounds and vulcanized antimicrobial rubber products”—refers to non-silicone rubber products featuring effective long wearing antimicrobial properties, in both solid and injected states (foam or sponge or multilayered combinations of such). It uses non-sulfur-based curing agents and systems, such as biphenols and peroxides that allow for vulcanization and don't irreversibly bond with silver ions, thereby resulting in a long-lasting antimicrobial performance of rubber products. It provides for a simple method for the production of a vulcanized non-silicone antimicrobial rubber product, in addition to specific pre-vulcanized non-silicone crude rubber formulations produced with non-silicon rubber which accounts for at least most of the product, by weight, said rubber being added with silver-based components to provide long-lasting antimicrobial characteristics to cured rubber products. It differs from the present patent in that it uses sulfur-based curing agents and systems whose formulation, in addition to silver, may contain zinc or no silver and only zinc and silica. These products are in their vulcanized solid state.

1. “ANTIMICROBIAL FORMULATION FOR RUBBER PLUCKER/DEHAIRER FINGERS”, characterized by a formulation using natural rubber (NR), synthetic polyisoprene (IR), polybutadiene rubber (BR), nitrile rubber (NBR), styrene-butadiene copolymer (SBR and SSBR), thermoplastic polyurethane (TPU), either plain or any mixture of such, until a level of parts per hundred rubber (PHR) is attained; with 30-100 natural rubber or synthetic polyisoprene (IR); 0-70 polybutadiene rubber (BR); 0-70 nitrile rubber (NBR); 0-70 styrene-butadiene rubber (SBR or SSBR); 30-100 thermoplastic polyurethane (TPU); containing 0.1-50 mineral oil-type plasticizers, and esters, 0.1-30 phthalate; containing 0.1-80 carbon black reinforcing loads or 0.1-80 precipitated silica, in addition to other kaolin-type semi-reinforcing loads, and aluminum silicate; as an activation system, 0.5-20 zinc oxide, 0.5-5 stearic acid, 0.1-10 polyethylene glycol (PEG); process aids; 0.1-8 combination of paraffins and/or fatty acids; as antioxidant 0.1-3 6PPD or IPPD (paraphenylenediamines), 0.1-3 of BHT, 0.1-5 polyethylene wax; for vulcanization, as a major curing agent, 0.5-8 sulfur, additionally containing sulfur donors, such as TMTD and DTDM; as an acceleration system, 0.1-3 sulfenamides (such as, but no limited to, NOBS, CBS, and TBBS), 0.1-3 thiurams (such as, but no limited to, TMTM, TMTD, and TBzTD), 0.1-3 DTDM (4.4′ dithiodimorpholine), 0.1-3 of dithiocarbamates (such as, but no limited to, ZDEC or ZDC, ZMDC, ZBDC, and ZBEC), 0.1-3 thiazoles (such as, but no limited to, MBT, and MBTS); containing such bactericed agents as 0.5-20 chitosan, 0.01-6 silver-, silver- and zinc-, or only zinc-based biocide.

2. “ANTIMICROBIAL FORMULATION FOR RUBBER PLUCKER/DEHAIRER FINGERS”, according to claim 1, characterized by the fact that it's obtained in four (4) phases, first by adding rubbers, second by mixing antioxidants and activators, third by mixing loads, process aids, and plasticizers, and fourth by adding the curing system and biocides.

3. “ANTIMICROBIAL FORMULATION FOR RUBBER PLUCKER/DEHAIRER FINGERS”, according to claims 1 and 2, characterized by the fact that, following the mixing phase, the formulated compounds are specifically processed as [symbol]
